(19) United States
(12) Patent Application Publication
(10) Pub. No.: US 2011/0313946 A1
(43) Pub. Date: Dec. 22, 2011

(54) SYSTEMS AND METHODS FOR ADMINISTERING COLLEGE SAVINGS PLANS

(76) Inventors: Stephen J. Browne, West Hartford, CT (US); Jeffrey T. Coghan, Avon, CT (US); Rodney R. Howard, Weatogue, CT (US); Taryn McCarthy Lisowski, Glastonbury, CT (US); Michael E. Myers, Simsbury, CT (US)

(21) Appl. No.: 13/116,182

(22) Filed: May 26, 2011

Related U.S. Application Data
(60) Provisional application No. 61/352,476, filed on Jun. 8, 2010.

(51) Int. Cl. G06Q 40/00

(52) U.S. Cl. 705/36 R; 705/39; 705/42

(57) ABSTRACT

According to some embodiments, first data to open an escrow account is received. The first data may include data indicative of (a) the name of a prospective parent of an unborn intended beneficiary of the escrow account, and (b) an amount to be deposited in the escrow account. A message may then be transmitted to indicate that the escrow account has been opened, and the message may include an account identification number of the escrow account. An indication that the intended beneficiary of the escrow account has been born may be received, and, in response to the indication, an instruction to convert the escrow account to a 529 college savings plan to benefit the intended beneficiary may be issued. Some embodiments are associated with a financial planning tool that receives first data indicating an age of a prospective college student along with second data indicating first investment holdings of a user, the first investment holdings not including any 529 college savings plan. Third data, indicating retirement savings objectives of the user, may also be received. Financial planning calculations may then be performed based on the first, second and third data. The financial planning calculations may, for example, generate a contribution recommendation for a 529 college savings plan to benefit the prospective college student.

### CROSS-REFERENCE TO RELATED APPLICATIONS

The present application claims the benefit of U.S. Provisional Patent Application No. 61/352,476 entitled “Systems and Methods for Administering College Savings Plans” filed on Jun. 8, 2010. The entire contents of that application are incorporated herein by reference.

### FIELD

The present invention relates to computer systems, and particularly to computer systems for administering financial products.

### BACKGROUND

Certain college savings plans, such as a 529 college savings plan, are financial products that allow for accumulation of assets for later expenditure on a beneficiary's qualified college expenses. The qualified college expenses may include, for example, tuition, fees, books, supplies, equipment and room and board.

The present inventors have now developed improved computer-based techniques for opening and/or administering 529 college savings plan accounts.

### SUMMARY

According to some embodiments, a system may include a handheld electronic device, a first server computer for administering 529 college savings plans, and a second server computer for storing and retrieving product pricing information. The handheld electronic device includes at least one processor and an application program for controlling the processor. The handheld electronic device is used to scan a product barcode on a product item and to transmit to one or more of the server computers data that indicates the product barcode. The handheld electronic device receives, from the first server, a message that indicates whether the product item qualifies for reimbursement under a 529 college savings plan. The handheld electronic device also receives, from the second server, information to indicate whether a better price is available for the product item.

In another aspect of the invention, an apparatus, method, computer system and computer-readable data storage medium may receive first data for opening an escrow account, where the first data includes data indicative of (a) the name of a prospective parent of an unborn intended beneficiary of the escrow account, and (b) an amount to be deposited in the escrow account. The apparatus, method, computer system and computer-readable data storage medium may further transmit a message to indicate that the escrow account has been opened, with the message including an account identification number that identifies the escrow account. The apparatus, method, computer system and computer-readable data storage medium may also receive an indication that the intended beneficiary has been born, and then issue an instruction to convert the escrow account to a 529 college savings plan to benefit the intended beneficiary.

In still another aspect, the apparatus, method, computer system and computer-readable data storage medium may receive first data that indicates the age of a prospective college student, second data that indicates investment holdings of a user (where the investment holdings do not include any 529 college savings plan), and third data that indicates retirement savings objectives of the user. The apparatus, method, computer system and computer-readable data storage medium may perform financial planning calculations based at least on the first, second and third data, with the calculations being for generating a contribution recommendation for a 529 college savings plan to benefit the prospective college student.

With these and other advantages and features of the invention that will become hereinafter apparent, the invention may be more clearly understood by reference to the following detailed description of the invention, the appended claims, and the drawings attached hereto.

### BRIEF DESCRIPTION OF THE DRAWINGS

FIG. 1 is a schematic illustration of a system for implementing a first aspect of the invention.

FIG. 2 is a simplified block diagram of a handheld electronic device that is part of the system of FIG. 1.

FIG. 3 is a block diagram representation of a server computer that is part of the system of FIG. 1.

FIGS. 4-6 are flow charts that illustrate processes that may be performed in the system of FIG. 1.

FIG. 7 is a schematic illustration of a system for implementing a second aspect of the invention.

FIG. 8 is a flow chart that illustrates a process that may be performed in the system of FIG. 7.

FIG. 9 is a schematic illustration of a system for implementing a third aspect of the invention.

FIG. 10 is a flow chart that illustrates a process that may be performed in the system of FIG. 9.

FIG. 11 is a tabular portion of a 529 college savings plan database according to some embodiments.

### DETAILED DESCRIPTION

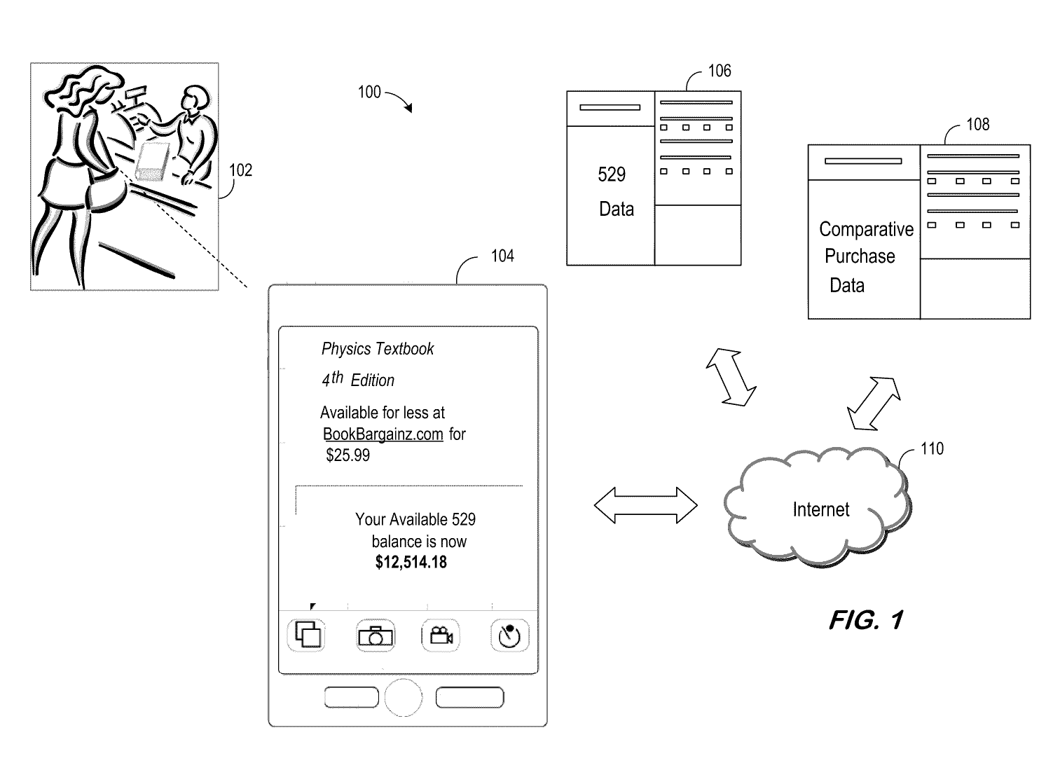

FIG. 1 is a schematic illustration of a system 100 for implementing a first aspect of the invention. Pictorial inset 102 in FIG. 1 shows a college student shopping at the college bookstore for books, supplies and/or equipment. Reference numeral 104 indicates the college student's handheld electronic device, which may, for example, be a smartphone such as the well-known iPhone marketed by Apple Inc. Alternatively, the handheld electronic device 104 may be a PDA with wireless data communication capabilities, such as a BlackBerry.

The system 100 also includes a 529 plan server 106, which is a server computer that administers 529 college savings plans. (For purposes of later discussion, it will be assumed that the college student depicted in FIG. 1 is the beneficiary of a 529 college savings plan account administered by the 529 plan server 106.) As used herein, the phrase “529 college savings plan” may refer to, for example, an investment vehicle in the United States designed to encourage saving for the future higher education expenses of a designated beneficiary. 529 college savings plans are named after section 529 of the

Internal Revenue Code 26 U.S.C. §529. Although states may administer some 529 college savings plans, record-keeping and administrative services may be delegated to a mutual fund company or other financial services company. In general, certain distributions from 529 college savings plans (e.g., for qualified higher education expenses) are considered “qualified” distributions. Note that any of the embodiments described herein may be associated with other types of college savings plans.

In addition, the system 100 includes a price comparison server computer 108, which provides real time comparison shopping services.

Communications among the handheld electronic device 104, the 529 plan server 106 and the price comparison server computer 108 may take place via the Internet, indicated by reference numeral 110.

In their hardware aspects, the handheld electronic device 104, the 529 plan server 106 and the price comparison server computer 108 may all be conventional, but one or more of them may be programmed to operate in accordance with aspects of the present invention and to provide functionality as described herein.

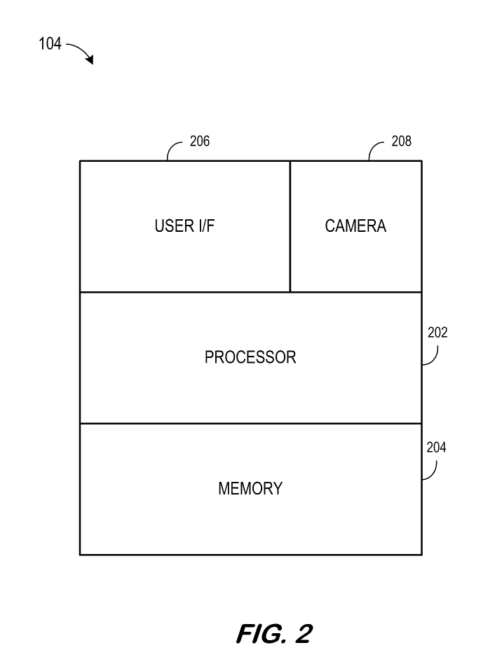

FIG. 2 is a simplified block diagram of the handheld electronic device 104.

Noting again that the hardware constituting the handheld electronic device 104 may be conventional, it will be observed that the device 104 includes a processor 202, one or more memory components 204 in communication with the processor 202, and a user interface 206 that is coupled to the processor 202. In addition, the handheld electronic device 104 includes a camera 208 that is controlled by the processor 202. The processor may be controlled by suitable software that is stored in the memory 204. The software may include a conventional operating system and one or more application programs (“apps”) including an app for providing 529-plan-related functionality as described herein. The user interface 206 may, for example, be provided largely by and through a touchscreen (not separately shown in FIG. 2) as in the above-mentioned iPhone and other smartphones.

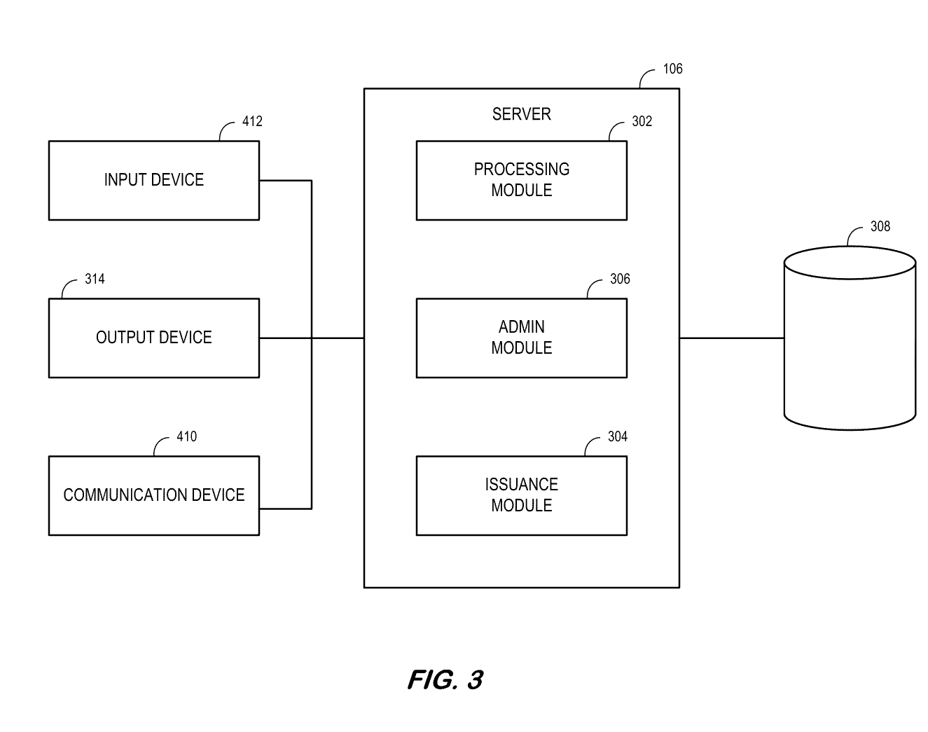

FIG. 3 is a block diagram representation of the 529 plan server 106. The 529 plan server 106 may be conventional in terms of its hardware aspects.

As depicted in FIG. 3, the 529 plan server 106 includes a processing module 302, which may be constituted by one or more conventional computer processors. The 529 plan server 106 further includes a plan account issuance module 304 which receives and/or generates data related to issuance of 529 college savings plan accounts. The plan account issuance module 304 may be constituted, at least in part, by the processing module 302 in combination with suitable software program instructions. The plan account issuance module 304 may operate generally in accordance with conventional practices, at least in regard to the invention as illustrated in FIG. 1.

The 529 plan server 106 further includes a plan administration module 306 which handles administration of 529 college savings plan accounts issued by the plan account issuance module 304. The plan administration module 306 may also be constituted, at least in part, by the processing module 302 in combination with suitable program instructions. Among other functions, the plan administration module 306 may receive requests from plan account beneficiaries for reimbursement of expenditures by the beneficiaries, and the plan administration module 306 may, when appropriate, issue the requested reimbursements. Aspects of the software program instructions for the plan administration module 306 will be described below. In some cases, the plan administration module 306 might be operated by a 529 college savings plan provider. Note, however, that the plan administration module 306 might be run by any other party, such as a third-party that administers various 529 college saving plans for different plan providers.

The 529 plan server 106 further includes one or more storage devices, represented by item 308 in FIG. 3. The storage devices 308 are coupled for data communication with the processing module 302 and may comprise any appropriate information storage device, including combinations of magnetic storage devices (e.g., magnetic tape and hard disk drives), optical storage devices, and/or semiconductor memory devices (such as Random Access Memory (RAM) devices and Read Only Memory (ROM) devices). At least some of these devices may be considered computer-readable storage media, or may include such media. The storage devices 308 may store the above-mentioned software program instructions and/or other program instructions to control the processing module 302 such that the 529 plan server 106 provides desired functionality, as described herein. Thus, the storage devices 308 store one or more programs for controlling the processing module 302. The processing module 302 performs instructions of the programs, and thereby operates in accordance with aspects of the present invention. In some embodiments, the programs may include one or more conventional operating systems.

The programs may further include application programs such as a conventional data communication program and a conventional database management program. Aspects of the application programs will be described below. Still further, the storage devices 308 may store one or more databases relating to 529 college savings plan accounts administered by the 529 plan server 106.

The 529 plan server 106 may further include one or more communication devices 310 coupled to the processing module 302. The communication devices 310 may function to facilitate communication with, for example, other devices (such as the handheld electronic device 104 and/or the price comparison server computer 108 shown in FIG. 1). In addition, the 529 plan server 106 may include one or more input devices 312 such as a keyboard, a keypad, a mouse or other pointing device, a microphone, knob or a switch, an infra-red (IR) port, a docking station and/or a touch screen. The input device(s) 312 may be coupled to the processing module 302. Still further the 529 plan server 106 may include one or more output devices 314, such as a display (e.g., a display screen), a speaker, and/or a printer. The output devices 314 may also be coupled to the processing module 302.

The 529 plan server 106 may be operated by an insurance company or other financial services company that handles investment programs such as 529 college savings plans.

The price comparison server computer 108 may also be conventional in its hardware aspects, and may be constituted by hardware that is similar to the above-described hardware aspects of the 529 plan server 106. The price comparison server computer 108 may be controlled by software programming that causes it to function in a manner that is described below.

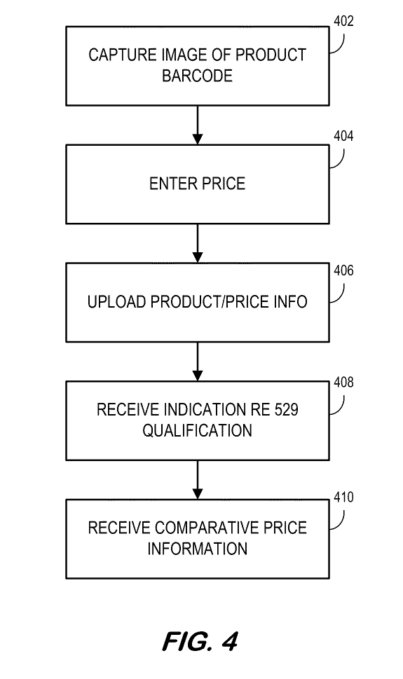

FIG. 4 is a flow chart that illustrates a process that may be performed by operation of the handheld electronic device 104 in accordance with aspects of the present invention. The ensuing description of FIG. 4 is premised on the assumption that the college student who operates the handheld electronic device 104 is engaged in shopping for books, supplies and/or equipment, e.g., at the college bookstore. It may also be assumed that the user/college student has invoked a 529 plan app provided in accordance with the invention and running on the handheld electronic device 104.

At 402 in FIG. 4, the college student tentatively selects a product item for purchase, and uses the camera 208 (FIG. 2) of the handheld electronic device 104 to capture an image of a product identification barcode carried on the product item. (Alternatively, the handheld electronic device 104 may include a conventional barcode scanner, which the college student may use to scan the product barcode.)

At 404 in FIG. 4, the college student enters, into the handheld electronic device 104, the price marked on the product item. (Alternatively, a suitable server—not shown—located in the bookstore may automatically download price information for the product item to the handheld electronic device 104 in response to the handheld electronic device 104 capturing the barcode and sending an inquiry to the bookstore server.)

At 406, the handheld electronic device 104 sends a data message to either or both of the 529 plan server 106 and the price comparison server computer 108, with the data message containing a string of digits that represent the barcode (i.e., a product identification number) and also containing the price information entered or received at 404.

At 408, the handheld electronic device 104 receives, from the 529 plan server 106, a data message that indicates whether the product item in question is an item that is qualified for reimbursement under the 529 plan. In addition or alternatively, the data message may also indicate the current available balance in the user's 529 college savings plan account. The data message may cause the handheld electronic device 104 to display corresponding information (e.g., “The item is approved” and/or “Your available 529 account balance is $XXXX.”) to the user.

At 410, the handheld electronic device 104 receives, from the price comparison server computer 108, a data message that indicates whether a better price for the product item is available through another shopping outlet. The latter data message may cause the handheld electronic device 104 to display information contained in the data message, such as “Did not find a better price” or “Available for less at BookBargainz.com for $25.99”.

The ensuing discussion assumes that the price comparison server computer 108 stores a database for translating the product barcode number into a product name, description, etc., and that the price comparison server computer 108 supplies this information to the 529 plan server 106 so that the 529 plan server 106 can determine whether the product item qualifies for reimbursement. However, in other embodiments of the system 100, the 529 plan server 106 has such a database, and is itself able to identify the product item after receiving the product barcode number from the handheld electronic device 104.

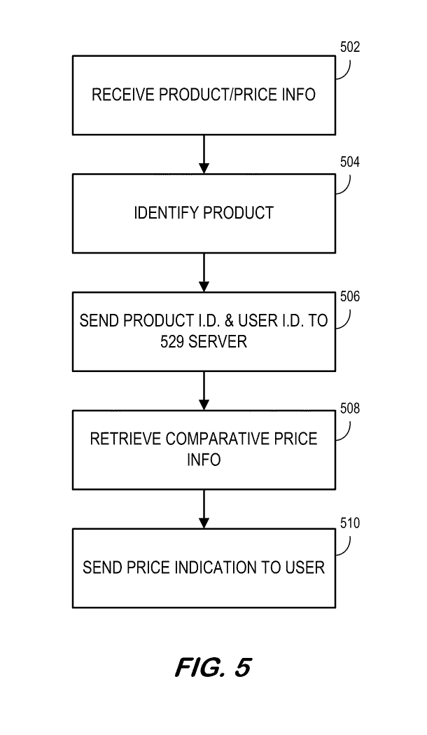

FIG. 5 is a flow chart that illustrates a process that may be performed in the price comparison server computer 108 in accordance with aspects of the present invention.

At 502 in FIG. 5, the price comparison server computer 108 receives the product barcode number and the product price information uploaded from the handheld electronic device 104 at step 406 in FIG. 4. The message from the handheld electronic device 104 which includes this information may also include an identification number and/or 529 savings plan account number for the user of the handheld electronic device 104. Then, at 504, the price comparison server computer 108 uses the above-mentioned database to identify the product and to access a description and/or category, etc., of the product.

At 506, the price comparison server computer 108 sends the product information and the user identification information/account number to the 529 plan server 106. Further, at 508, the price comparison server computer 108 determines whether the product item is available for a better price at a retail outlet other than the store where the user is currently shopping. The price comparison server computer 108 may make this determination, for example, based on one or both of the following activities: (A) accessing a price database that is frequently updated with information about the pricing at various retail outlets of a universe of product items; and/or (B) doing a real time web search for price comparison shopping.

At 510, and based on a result of step 508, the price comparison server computer 108 sends a message to the handheld electronic device 104 to indicate either that a better price was found for the product item, or that a better price was not found. In the former case, the price comparison server computer 108 may provide details to the handheld electronic device 104, such as the retail outlet with the best price, and what that price is.

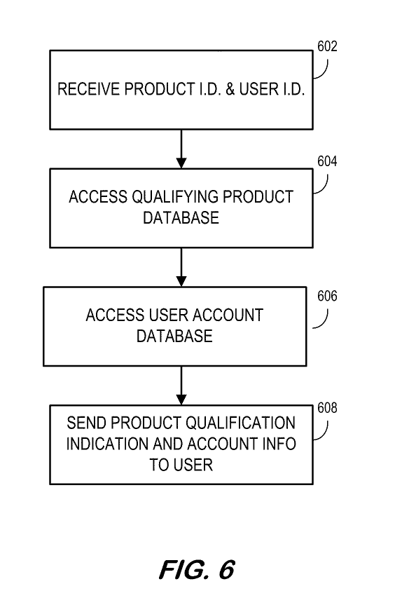

FIG. 6 is a flow chart that illustrates a process that may be performed in the 529 plan server 106 in accordance with aspects of the present invention.

At 602 in FIG. 6, the 529 plan server 106 receives the product item information and the user identification information/account number transmitted by the price comparison server computer 108 at step 506 in FIG. 5. At 604 in FIG. 6, the 529 plan server 106 accesses a database of product items which identifies product items that qualify for reimbursement under 529 college savings plans. (In addition, or alternatively, the 529 plan server 106 may apply rules-based processing or other techniques to determine whether the product item in question qualifies for reimbursement.)

At 606, the 529 plan server 106 uses the user identification information/account number to access an account database in order to determine the available balance of funds in the user's 529 plan account.

At 608, based on results of steps 604 and 606, the 529 plan server 106 sends a message to the handheld electronic device 104 to indicate to the user whether the product item qualifies for reimbursement, and also to indicate the available balance in the user's 529 plan account. For the purposes of this message, for example, the 529 plan server 106 may have received information for addressing the handheld electronic device 104 from the 529 plan server 106 as part of the user identification information sent at 506 and received at 602. Alternatively, however, the 529 plan server 106 may have had the addressing information available in the user account database that was accessed at 606. As a result of the message sent by the 529 plan server 106 at 608, the handheld electronic device 104 may display the corresponding information to the user.

In some embodiments, the user/account holder may, upon making the purchase for the item, use the handheld electronic device 104 to confirm to the 529 plan server 106 that the purchase has been made, and to automatically apply for reimbursement from the user's 529 plan account. The 529 plan server 106 may receive the message and implement the requested reimbursement to the user/account holder (e.g., via automatic funds transfer to the user's demand deposit account at another financial institution, which is not shown).

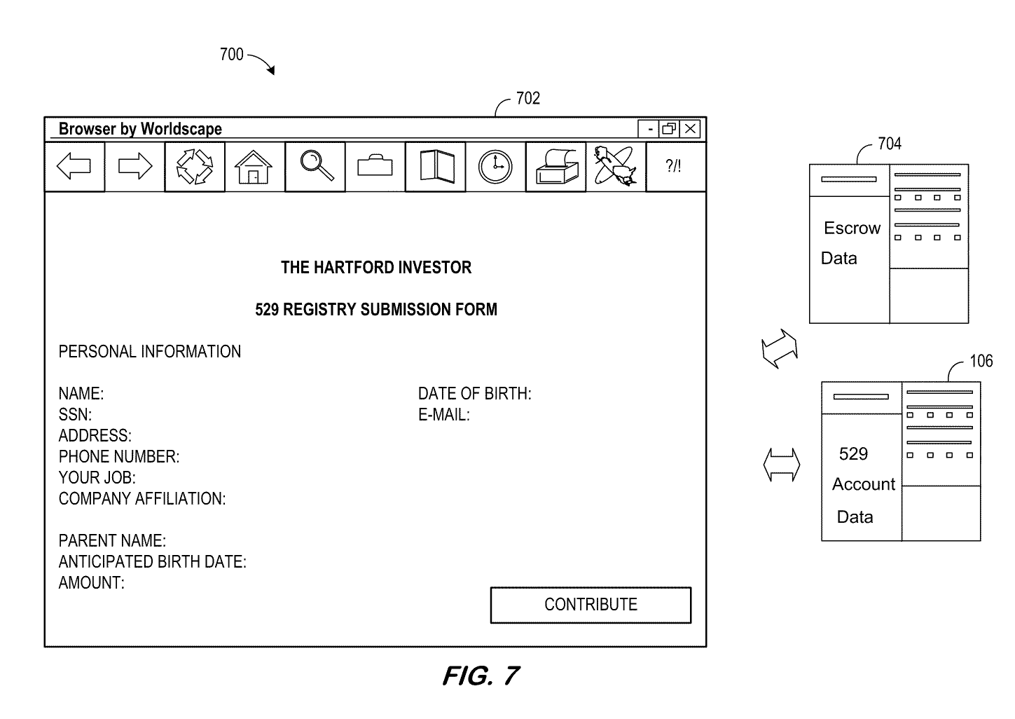

FIG. 7 is a schematic illustration of a system 700 for implementing a second aspect of the invention. The system 700 may implement a pre-birth gift registry to allow for establishment of escrow accounts that are to be converted to 529 savings accounts upon a beneficiary's birth.

Reference numeral 702 indicates a screen display that may be presented by the browser of a donor's personal computer (PC). (The donor's PC is not shown, apart from the screen display 702.) The screen display 702 may be presented by the donor's PC in response to the donor's navigation to a 529 gift registry web page hosted by an escrow account server computer 704. The escrow account server computer 704 may be operated by an insurance company or other financial institution that offers 529 college savings plans. Note that the screen display 702 might be associated with, by way of examples only, a social networking page (e.g., a Facebook page), a link from a children's clothing store, and/or an electronic birth announcement or similar message (e.g., an electronic invitation to a baby shower that includes a link that will take the invitee to the screen display 702).

It will be noted that the screen display 702 includes a data entry form. The donor may interact with the data entry form to enter information to specify a gift of funds to be deposited into a 529 college savings plan account for an unborn child. The donor may enter information into the form to identify the intended beneficiary by the parent's name and by the beneficiary's expected date of birth.

A 529 plan administrative computer operated by the financial institution may also be part of the system 700. The computer referred to in the previous sentence may, in its hardware aspects, and in many of its software aspects, be similar to the 529 plan server 106 discussed above with reference to FIGS. 1 and 3. Consequently, this computer is also indicated by reference numeral 106 in FIG. 7. Moreover, the escrow account server computer 704 may also be similar in its hardware aspects to the 529 plan server 106 shown in FIG. 3. Indeed, the escrow account server computer 704 and the 529 plan server 106 may be integrated together at least in terms of their hardware aspects.

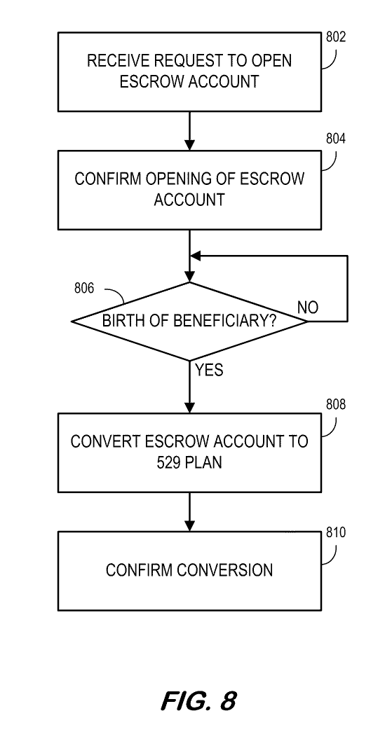

FIG. 8 is a flow chart that illustrates a process that may be performed in the system 700. In some embodiments, the process of FIG. 8 may be performed primarily by the escrow account server computer 704.

At 802 in FIG. 8, the escrow account server computer 704 receives a request from the donor to open an escrow account pursuant to a pre-birth gift registry for a 529 college savings plan. The donor may make this request via the browser on the donor's PC and via the screen display 702 and a web page hosted via the escrow account server computer 704, as described above with reference to FIG. 7. According to other embodiments, the request may be generated via a smartphone app, wireless telephone, Automated Teller Machine (ATM), or store kiosk. The information received from the donor may identify the donor and include an authorization to charge the donor's payment card account to fund the amount of the gift for deposit into the escrow account. The information received from the donor may also identify the intended, unborn beneficiary by identifying the beneficiary's parent(s) and by indicating the expected date of birth for the beneficiary.

At 804, the escrow account server computer 704 may send a message to the donor to confirm that the escrow account has been opened and funded for the benefit of the intended beneficiary. At the same time, the escrow account server computer 704 may send a message to the beneficiary's parent(s) to provide notification of the gift to their unborn child.

As indicated by decision block 806, the escrow account server computer 704 may then wait to receive notification that the intended beneficiary has been born. Such a notification may, for example, come from the donor or from the beneficiary's parent. In some embodiments, the escrow account server computer 704 may send periodic reminders to the donor or the parent(s) at intervals after the expected date of birth if the escrow account server computer 704 has not in the meanwhile received notification of the beneficiary's birth.

Once the escrow account server computer 704 receives notification of the beneficiary's birth, block 808 follows decision block 806. At 808, the escrow account server computer 704 may automatically issue instructions to the 529 plan server 106 and/or may transfer funds from the escrow account such that a 529 college savings plan account is automatically opened for the benefit of the beneficiary. As used herein, the term “automatically” may refer to a process or step that is performed with little or no human intervention. Suitable data records for the 529 plan account may be established automatically in the 529 plan server 106. At 810, the escrow account server computer 704 and/or the 529 plan server 106 sends a message to the beneficiary's parent and/or to the donor to confirm that the 529 plan account for the beneficiary has been established.

In some embodiments, the expectant parents may set up the gift registry for the escrow/529 plan account through a software application provided by the issuing financial services company whereby the parents establish a posting on their social networking page requesting gifts from friends for the child's college fund. The posting may contain a hyperlink that leads the friends/donors to the screen display 702 discussed above in connection with FIG. 7. Although the above discussion has only referred to one donor, in some embodiments multiple donors may make gifts into the same escrow account. In some embodiments, multiple escrow accounts may be established, and then combined together upon conversion to the 529 plan account.

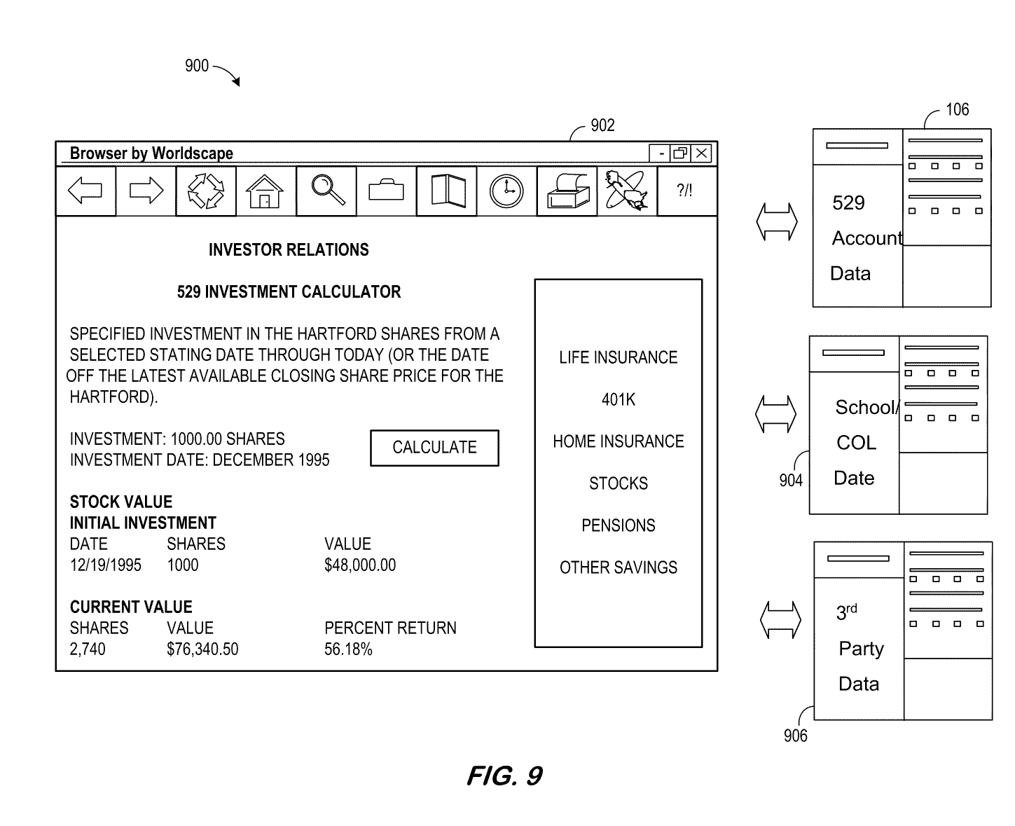

FIG. 9 is a schematic illustration of a system 900 for implementing a third aspect of the invention. The system 900 may implement a website that generates and provides to a user recommendations about funding levels for a 529 college savings plan based on a “holistic” view of the user's other investment holdings and objectives.

Reference numeral 902 indicates a screen display that may be presented by the browser of the user's PC. (The user's PC is not shown, apart from the screen display 902.) The screen display 902 may be presented to the user's PC in response to the user's navigation to a college saving plan “calculator” web page. The web page may, for example, be hosted by a 529 plan server (again indicated by reference numeral 106 in FIG. 9), or by another web server (not separately shown). Other sources/repositories of information included in the system 900 may include a college information server 904 and a third party data supplier server 906. Again, all of the hardware aspects of system 900 may be conventional, and at least the hardware architecture of servers 904 and 906 may be like that depicted in FIG. 3.

The screen display 902 may in general resemble conventional 529 plan calculator pages, but with additional input fields that allow the user to present a comprehensive picture of his/her investment holdings and objectives.

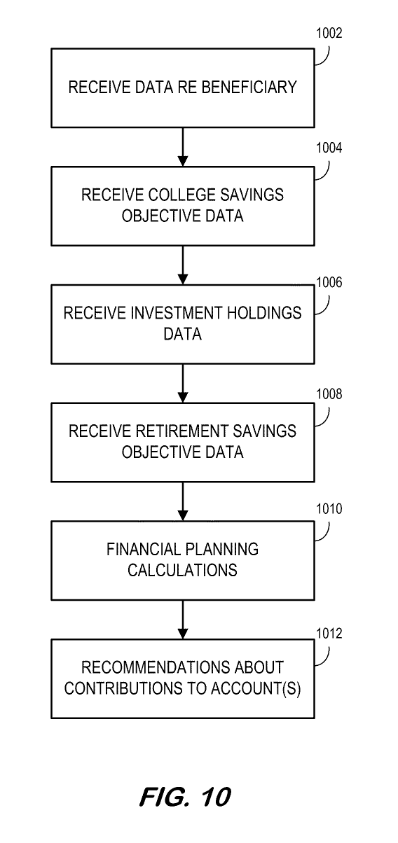

FIG. 10 is a flow chart that illustrates a process that may be performed in accordance with the invention in the computer (e.g., 529 plan server 106) which hosts the web page represented by screen display 902.

At 1002 in FIG. 10, the 529 plan server 106 receives, from the user, data related to the intended beneficiary of the 529 plan account. For example, this data may include the beneficiary's age and/or date of birth.

At 1004 the 529 plan server 106 receives, from the user, data related to objectives for the 529 plan account. The data related to objectives might include, for example, whether the account is expected to be used in connection with a 4-year college or a 2-year college. As another example, the data related to objectives might comprise a rate of return to be assumed. The rate of return to be assumed might, for example, come from the user, the calculator (e.g., as pre-defined by a college savings plan provider), or a third-party (e.g., governmental interest rates might be used to calculate a likely rate of return). Other examples of data related to objectives might include a rate of inflation to be assumed for college tuition charges (e.g., as provided by the user, the calculator itself, or a third-party), assumed current tuition charges, whether attendance will be full- or part-time, a percentage of anticipated college costs to be covered by the 529 plan account, etc.

At 1006 the 529 plan server 106 receives information about the user's investment holdings. This information may be input by the user into data entry fields of the screen display 902. More preferably, however, this information may be received by the 529 plan server 106 from the third party data supplier server 906. For example, the third party data supplier server 906 may host a “My Money” website on which individuals and families are able to store, access and update records of their investment holdings. The holdings in question may include 401(k) accounts, mutual funds, individual stock and bond holdings, cash holdings, vested pensions, etc.

At 1008 the 529 plan server 106 receives information about the user's retirement savings objectives. Again this information may be input by the user or transferred from the third party data supplier server 906. This information may include, for example, the user's intended retirement age, the amount he/she aims to have accumulated in retirement savings by the time of retirement, current monthly contributions to retirement savings plans, etc. According to some embodiments, the 529 plan server 106 is adapted to perform calculations in connection with a number of different 529 college saving plans (e.g., to facilitate family education planning when there are multiple children of different ages).

At 1010 the 529 plan server 106 performs financial planning calculations that are based on all of the information received in steps 1002-1008. That is, these calculations reflect all of the user's investment positions, retirement as well as college savings objectives, and the intended college savings beneficiary's age (i.e., expected date of enrollment in college). A possible outcome of these calculations may be a recommendation to the user as to how much he/she should contribute to a 529 plan account on a monthly/annual basis to communication with each other and/or operated by a single organization or by two or more organizations that are partly or entirely under common ownership and/or control. According to some embodiments, the recommendation might indicate whether the user is on pace, ahead of schedule, or behind schedule in connection with a 529 college savings plan account.

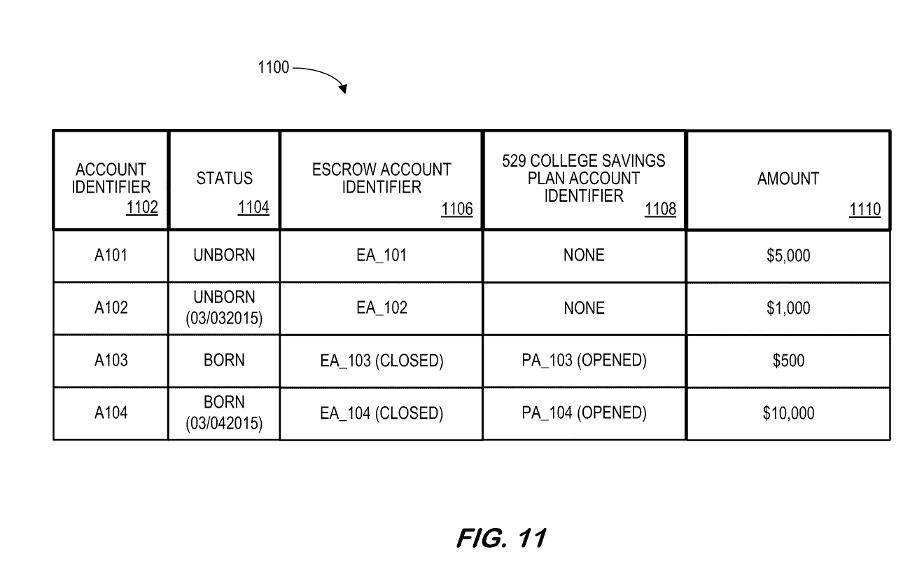

According to some embodiments, a 529 college saving plan account might be structured as or otherwise associated with a Guaranteed Minimum Accumulated Benefit (“GMAB”) annuity investment vehicle. The GMAB annuity might be, for example, structured such that the account value will be at a certain amount at a certain point in the future, such as by investing assets in one or more funds (e.g., associated with government bonds of various credit ratings, corporate bonds, asset backed securities, commercial mortgage backed securities, index funds, balanced equity funds, and/or stable bond funds). According to some embodiments, the GMAB annuity might be structured such that the account value will represent at least the total value of investments that were made to the account (even if certain underlying investments decrease in value). In some cases, a GMAB annuity might invest in various blended target date funds (e.g., having a ratio of stocks to bonds that might be classified as “conservative” or “moderate” depending on the age of the beneficiary). Note that a 529 college savings plan account investment option may might be associated with certain age restrictions. For example, a new 529 savings plan associated with a GMAB annuity might only be available if a child is 13 years old or younger. The owner might, for example, input a starting age for the child into the financial calculator along with a “goal amount” for a 529 college savings plan. The calculator might then provide a required amount of deposits/premiums (e.g., per month) to achieve a desired amount in view of the child's age. Withdrawals from a 529 savings plan associated with a GMAB annuity might also be limited with respect to amounts/percentages over various time periods. For example, a maximum of 25% of the total savings in the plan might be allowed to be withdrawn each year over a four year period. FIG. 11 is a tabular portion of a 529 college savings plan database 1100 according to some embodiments. The 529 college savings plan database 1100 might be associated with, for example, the storage device 308 described with respect to FIG. 3. The table may include, for example, entries identifying plans that have been or will be established on behalf of beneficiaries. The table may also define fields 1102, 1104, 1106, 1108, 1110 for each of the entries. The fields 1102, 1104, 1106, 1108, 1110 may, according to some embodiments, specify: an account identifier 1102, a status 1104, an escrow account identifier 1106, a 529 college savings plan account identifier 1108, and an amount 1110. The information in the 529 college savings plan database 1100 may be created and updated, for example, whenever data is received from a donor, parent, or financial institution.

The account identifier 1102 may be, for example, a unique alphanumeric code identifying a request to open a 529 college savings plan account. The account identifier 1102 could comprise, for example, the name or other information identifying a donor or parent. The status 1104 might indicate, for example, whether or not the intended beneficiary associated with the request has been born. According to some embodiments, the status 1104 might further indicate a date on which the intended beneficiary was (or is expected to be) born.

The escrow account identifier 1106 might comprise a number identifying a financial account that was opened in response to the request. According to some embodiments, the escrow account identifier 1106 might further indicate whether or not is has been closed (e.g., after being converted to a 529 college savings plan). The 529 college savings plan account identifier 1108 might comprise a number identifying a financial account that was opened in response to the request. According to some embodiments, the 529 college savings plan account identifier 1108 might further indicate whether or not is has opened (e.g., after the intended beneficiary has been born). The amount 1110 might represent, for example, a dollar value indicating how much money is in the account associated with the escrow account identifier 1106 or 529 college savings plan account identifier 1108.

Note that according to some embodiments, multiple requests and/or account identifiers 1102 might be associated with a single escrow account identifier 1106 and/or 529 college savings plan account identifier 1108. Similarly, multiple escrow account identifiers 1106 and/or 529 college savings plan account identifiers 1108 might be associated with a single requests and/or account identifier 1102. Further note that the 529 college savings plan database 1100 may store information in addition to that illustrated in FIG. 11. For example, the 529 college savings plan database 1100 might store an address, a Social Security number, and/or a credit or debit cart number associated with a donor, parent, or intended beneficiary.

As used herein and in the appended claims, the term “processor” refers to one processor or two or more processors that are in communication with each other.

As used herein and in the appended claims, the term “memory” refers to one, two or more memory and/or data storage devices.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A computer system to facilitate provisioning college saving plans for beneficiaries, comprising:
a processor; and
a memory in communication with the processor and storing program instructions, the processor operative with the program instructions to:
receive first data for opening an escrow account, the first data including data indicative of (a) the name of a prospective parent of an unborn intended beneficiary of the escrow account, and (b) an amount to be deposited in the escrow account,
transmit a message to indicate that the escrow account has been opened, the message including an account identification number that identifies the escrow account,
receive an indication that the intended beneficiary of the escrow account has been born, and
in response to receiving the indication, issue an instruction to convert the escrow account to a 529 college savings plan to benefit the intended beneficiary.

2. The computer system of claim 1, wherein the processor is further operative with the program instructions to:
send a message to a donor of the amount deposited in the escrow account, said message to the donor indicative that the escrow account has been converted into the 529 college savings plan.

3. The computer system of claim 1, wherein the processor is further operative with the program instructions to:
send a message to the parent of the intended beneficiary, said message to the parent of the intended beneficiary indicative that the escrow account has been converted into the 529 college savings plan.

4. The computer system of claim 1, wherein the amount to be deposited in the escrow account is received from multiple donors.

5. The computer system of claim 4, wherein the received first data includes an expected date of birth of the unborn intended beneficiary.

6. The computer system of claim 1, wherein first data is received from at least one of: (i) a web browser executing at a donor device, or (ii) an application executing at a smartphone.

7. The computer system of claim 1, wherein the processor is further operative with the program instructions to:
automatically establish suitable data records for 529 college savings plan.

8. The computer system of claim 1, wherein the received first data is linked to a gift registry associated with the unborn intended beneficiary.

9. The computer system of claim 1, wherein the processor is further operative with the program instructions to:
periodically transmit a reminder to a donor or to the prospective parent until the indication that the intended beneficiary has been born is received.

10. The computer system of claim 1, wherein the processor is further operative with the program instructions to:
receive, from a handheld electronic device, data indicative of a product barcode obtained by the handheld electronic device by scanning the product barcode on a product item; and
transmit, to the handheld electronic device, an indication as to whether the product item qualifies for reimbursement pursuant to the 529 college savings plan.

11. The computer system of claim 10, wherein the processor is further operative with the program instructions to:
transmit, to the handheld electronic device, an indication as to whether a better price is available for the product item.

12. A computer implemented method to facilitate provisioning college saving plans for beneficiaries, comprising:
receiving first data for opening an escrow account, the first data including data indicative of (a) the name of a prospective parent of an unborn intended beneficiary of the escrow account, and (b) an amount to be deposited in the escrow account;
transmitting a message to indicate that the escrow account has been opened, the message including an account identification number that identifies the escrow account;
receiving an indication that the intended beneficiary of the escrow account has been born; and
in response to receiving the indication, automatically issuing an instruction to convert the escrow account to a 529 college savings plan to benefit the intended beneficiary.

13. The method of claim 12, further comprising:
sending a message to a donor of the amount deposited in the escrow account, said message to the donor indicative that the escrow account has been converted into the 529 college savings plan.

14. The method of claim 12, further comprising:
sending a message to the parent of the intended beneficiary, said message to the parent of the intended beneficiary indicative that the escrow account has been converted into the 529 college savings plan.

15. The method of claim 12, wherein the amount to be deposited in the escrow account is received from multiple donors.

16. The method of claim 12, further comprising:
automatically establishing suitable data records for 529 college savings plan.

17. The method of claim 16, wherein the 529 college savings plan is associated with a Guaranteed Minimum Accumulated Benefit (“GMAB”) annuity investment vehicle.

18. The method of claim 12, wherein the received first data is linked to a gift registry associated with the unborn intended beneficiary.

19. The method of claim 12, wherein the amount to be deposited in the escrow account is received from multiple donors, and further comprising:
sending messages to the multiple donors, said messages to the donors indicative that the escrow account has been converted into the 529 college savings plan;
sending a message to the parent of the intended beneficiary, said message to the parent of the intended beneficiary indicative that the escrow account has been converted into the 529 college savings plan; and
automatically establishing suitable data records for 529 college savings plan, wherein the received first data is linked to a gift registry associated with the unborn intended beneficiary.

20. A computer system to facilitate financial planning in connection with college saving plans, comprising:
a processor; and
a memory in communication with the processor and storing program instructions, the processor operative with the program instructions to:
receive first data indicative of an age of a prospective college student;
receive second data indicative of first investment holdings of a user, said first investment holdings not including any 529 college savings plan;
receive third data indicative of retirement savings objectives of the user; and
perform financial planning calculations based at least on said first, second and third data, said financial planning calculations for generating a contribution recommendation for a 529 college savings plan to benefit the prospective college student.

21. The computer system of claim 20, wherein the processor is further operative with the program instructions to:
receive fourth data indicative of college savings objectives of the user;
and wherein said financial planning calculations are also based on said fourth data.

22. The computer system of claim 21, wherein the first investment holdings include at least one of a variable annuity and a retirement savings account.

23. The computer system of claim 20, wherein the 529 college savings plan is associated with a Guaranteed Minimum Accumulated Benefit (“GMAB”) annuity investment vehicle.
